(19) United States
(12) Patent Application Publication
(10) Pub. No.: US 2017/0149800 A1
(43) Pub. Date: May 25, 2017

(54) SYSTEM AND METHOD FOR INFORMATION SECURITY MANAGEMENT BASED ON APPLICATION LEVEL LOG ANALYSIS

(71) Applicant: INSTITUTE FOR INFORMATION INDUSTRY, TAIPEI CITY (TW)

(72) Inventors: CHIH-HUNG HSIEH, TAOYUAN CITY (TW); CHIA-MIN LAI, NEW TAIPEI CITY (TW); CHING-HAO MAO, TAIPEI CITY (TW)

(21) Appl. No.: 14/959,685

(22) Filed: Dec. 4, 2015

(30) Foreign Application Priority Data
Nov. 20, 2015 (TW) 104138484

(51) Int. Cl. H04L 29/06

(52) U.S. Cl. CPC H04L 63/14

(57) ABSTRACT

The instant disclosure illustrates a system and method for information security management based on application level log analysis. The system and method for information security management involve analyzing a plurality of application level logs of a user and modeling the continuative behaviors of the user. Furthermore, the system and method for information security management include the selection of models according to different environmental contexts, thereby efficiently determining whether the user has had an abnormal behavior occur.

### BACKGROUND

1. Technical Field

The instant disclosure relates to a system and method for information security management, in particular, to a system and method for information security management based on application level log analysis.

2. Description of Related Art

Systems for information security management in the prior arts generally utilize a blacklist filtering mechanism using firewall to achieve the purpose of information security. However, in order to employ the above process efficiently, a filtering list predetermined by technicians is necessary. Accordingly, the above process is limited to a fixed expert rule and lacks flexibility and application diversity.

In addition, recently, there is a rise regarding the use of internet level log (for example, firewall log or package flow, etc.) to conduct data analysis and identification for achieving the purpose of information security monitoring. However, based on the existing technical means, regarding information security systems based on internet level log and methods using the same, there are still plenty of disadvantages and problems to solve. For instance, it is hard to find out the actual behavior and intension of the user, and still unable to perform adequate adjustment according to different application fields or contexts.

Therefore, in view of the rise of advanced persistent threat (APT), the systems and the methods for information security management based on internet level log analysis are insufficient for maintaining the security of information safety.

### SUMMARY

An exemplary embodiment of the instant disclosure provides a system for information security management based on application level log analysis, comprising a detecting module, a context-aware learner, a personal behavioral modeling learner, and an integrated analysis module. The detecting module is configured to retrieve a plurality of context characteristic values and a plurality of behavioral sequential data according to a plurality of application level logs of a user. The context-aware learner is configured to analyze the context characteristic values and create a plurality of context recognition indexes associated with the user. The personal behavioral modeling learner is configured to model the behavioral sequential data and create a plurality of behavioral evaluation models associated with the user. The integrated analysis module is configured to integrate the context recognition indexes and the behavioral evaluation models, and create a plurality of event combinations associated with the user. The integrated analysis module conducts a comparison between a series of continuative behaviors currently performed by the user and the event combinations for judging whether an abnormal behavior occurred within the series of continuative behaviors, wherein each of the event combinations comprises at least one of the context recognition indexes and at least one of the behavioral evaluation models.

Another exemplary embodiment of the instant disclosure provides a method for information security management based on application level log analysis, the method is adapted to a system comprising a detecting module, a context-aware learner, a personal behavioral modeling learner, and an integrated analysis module. The method comprises the steps of retrieving a plurality of context characteristic values and a plurality of behavioral sequential data according to a plurality of application level logs of a user by the detecting module; analyzing the context characteristic values by the context-aware learner to create a plurality of context recognition indexes associated with the user; modeling the behavioral sequential data by the personal behavioral modeling learner to create a plurality of behavioral evaluation models associated with the user; integrating the context recognition indexes and the behavioral evaluation models by the integrated analysis module to create a plurality of event combinations associated with the user; and comparing the event combinations with a series of continuative behaviors currently performed by the user by the integrated analysis module so as to judge whether an abnormal behavior occurred within the series of continuative behaviors, wherein each of the event combinations comprises at least one of the context recognition indexes and at least one of the behavioral evaluation models.

To sum up, the system and method for information security management based on application level log analysis provided by the embodiments of the instant disclosure mainly adopts analyzing a plurality of application level logs of a user and modeling the continuative behaviors of the user. Meanwhile, the selection of models under different contexts is also considered, thereby efficiently judging whether there is an abnormal behavior performed by the user. In addition, since the embodiments of the instant disclosure are carried out by modeling and judging based on the continuative behaviors of the user, they are able to efficiently identify the intention of the user by analyzing the differences within the continuative behaviors, thereby increasing the accuracy of the judgment of the abnormal behavior.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a functional block diagram of a system for information security management based on application level log analysis provided by the embodiments of the instant disclosure.

FIG. 2 is a schematic view of one of the event combinations provided by the embodiments of the instant disclosure.

FIG. 3 is a schematic view of continuative behaviors currently performed by the user provided by the embodiments of the instant disclosure.

FIG. 4 is a schematic view of the interaction between the context-aware learner and personal behavioral modeling learner of the system for information security management provided by the embodiments of the instant disclosure.

FIG. 5 is a flow chart of a method for information security management based on application level log analysis provided by the embodiments of the instant disclosure.

FIG. 6 is a flow chart for judging whether an abnormal behavior occurred within the continuative behaviors by the integrated analyzing module in the method for information security management provided by the embodiments of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

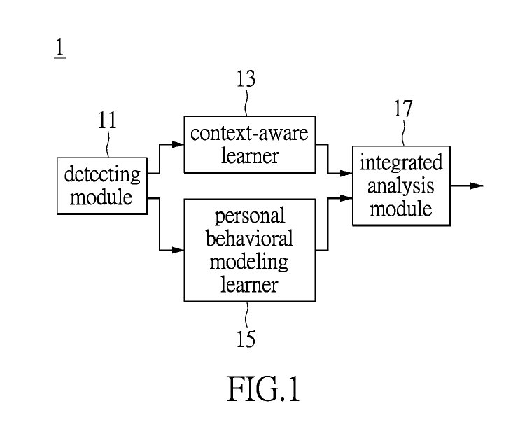

Please refer to FIG. 1. FIG. 1 is a functional block diagram of an system for information security management based on application level log analysis provided by the embodiments of the instant disclosure. The system 1 comprises a detecting module 11, a context-aware learner 13, a personal behavioral modeling learner 15 and an integrated analysis module 17. The above elements may be realized by purely hardware circuits, or by the combination of hardware and firmware or software. However, the instant disclosure is not limited thereto. In addition, the above elements may be integrated with each other or may be positioned separately, and the instant disclosure is not limited thereto. It is worthwhile to mention that the system 1 shown in FIG. 1 was only an implantation of the method for information security management, and the instant disclosure is not limited thereto.

To be specific, the detecting module 11 retrieves a plurality of context characteristic values and a plurality of behavioral sequential data according to a plurality of application level logs (not shown) of an user. The context-aware learner 13 analyzes the context characteristic values to create a plurality of context recognition indexes associated with the user. The personal behavioral modeling learner 15 models the behavioral sequential data to create a plurality of behavioral evaluation models associated with the user. The integrated analysis module 17 integrates the context recognition indexes and the behavioral evaluation models to create a plurality of event combinations associated with the user, and compares a series of continuative behaviors currently performed by the user with the event combinations to judge whether there is an abnormal behavior occurred within the series of continuative behaviors.

To be specific, the system 1 may receive a plurality of application level logs associated with the user through a log recorder (not shown) before the detecting module 11 executes. Next, the detecting module 11 analyzes all the descriptions in the application level logs and retrieves a plurality of context characteristic values and a plurality of behavioral sequential data. It is worthwhile to mention that the means for accessing the application level logs is not limited in the instant disclosure and may be designed and chosen by those skilled in the art based on actual need or application. In addition, since the technical feature of the application level log is well known to those skilled in the art, the details thereof will not be described herein.

For instance, when the detecting module 11 analyzes a plurality of status codes recorded by the application level logs and learns that the user has performed a series of continuative behaviors (for example, first, receiving e-mails by Outlook; second, sending out a plurality of e-mails by Outlook; and at last, browsing Facebook), the detecting module 11 further retrieves this series of continuative behaviors as one of the behavioral sequential data. According to the above description, those skilled in the art would acknowledge that the context characteristic values correspond to the time, location or any context awareness information during the performance of a certain series of continuative behaviors. It is worthwhile to mention that the means for retrieving the context characteristic values and behavioral sequential data and the specific forms of the context characteristic values and behavioral sequential data are not limited in the instant disclosure and may be designed and chosen by those skilled in the art based on actual need or application.

Based on the above description and the knowledge in the art, those skilled in the art would understand that analysis of an application level log which has a higher level eliminates the need of connecting to a specific internet hardware device as support and has an advantage of high readability. Therefore, compared to the prior art based on internet level log analysis, the instant disclosure is suitably adapted to the present electric devices and reinforces the management of information security. Moreover, application level services already are capable of high realization of “user intention”, therefore, there is no need to further consider the reliability of the description when analyzing based on application level log.

Specifically, assuming that there are application level logs recording the everyday behavior of a same user in a personal computer under an office environment, the system 1 first activates the detecting module 11 for analyzing the application level logs, thereby retrieving a plurality of context characteristic values and a plurality of personal behavioral sequential data. The context characteristic values and the personal behavioral sequential data serve as input data for processing the context-aware learner 13 and personal behavioral modeling learner 15, respectively.

For example, the context recognition indexes created by the context-aware learner 13 may be “working hours on Monday”, “non-working hours on Monday”, “working hours on Tuesday”, “non-working hours on Tuesday”, or “working hours on Wednesday”, etc. The behavioral evaluation models created by the personal behavioral modeling learner 15 may be a Markov Model of any one series of continuative behaviors. Since the Markov Model is well known in the art, the details thereof will not be described herein.

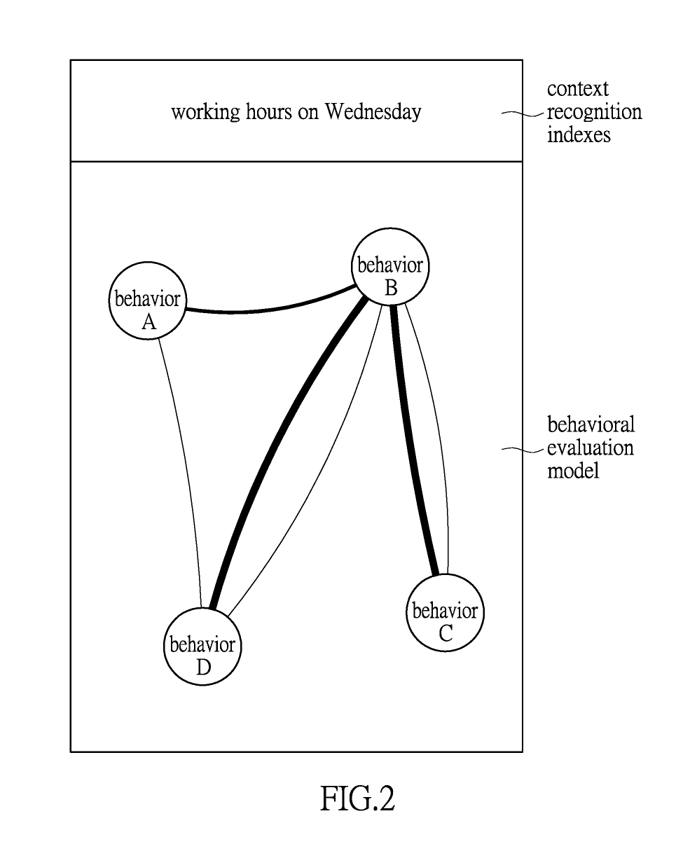

Furthermore, please refer to FIG. 2. FIG. 2 is a schematic view of one of the event combinations provided by the embodiments of the instant disclosure. The event combination shown in FIG. 2 illustrates a Markov Model of a series of continuative behaviors that may be performed by the user during the working hours on Wednesday (i.e., a context recognition index). According to the description above, those skilled in the art would understand that each of the event combinations is correspondingly guided to one of the behavioral evaluation models by the context recognition index thereof. It is worthwhile to mention that the specific forms of the above context recognition index and behavioral evaluation models are for illustrative purpose only and the instant disclosure is not limited thereto.

Incidentally, since the above example is under a fixed environment, only the contexts under different times (for example, “working hours on Monday”, “non-working hours on Monday”, etc.) have to be considered for selecting the corresponding behavioral evaluation model. Therefore, in the above example, each of the event combinations would only comprise one of the behavioral evaluation models as shown in FIG. 2. However, the instant disclosure is not limited thereto. For example, if the instant disclosure is carried out under a variable environment, the embodiments of the instant disclosure may consider the multiple contexts at different locations (for example, “location A”, “location B”, etc.) and at different times for selecting the corresponding behavioral evaluation model. In other words, each of the event combinations may comprise at least one of the context recognition indexes, and one of the behavioral evaluation models.

To sum up, according to the above description, those skilled in the art would understand that the main spirit of the embodiments of the instant disclosure resides in integrating the results input by the context-aware learner 13 and the personal behavioral modeling learner 15 respectively (i.e., the context recognition indexes and the behavioral evaluation models) by the integrated analysis module 17 to summarize the Markov Model of a series of continuative behaviors (i.e., behavioral evaluation model) that may be performed by the user at each specific context (i.e., each of the context recognition indexes).

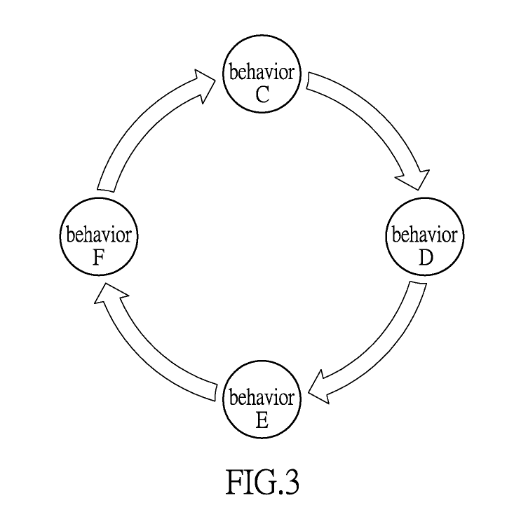

Next, the integrated analysis module 17 compares the series of continuative behaviors currently performed by the user with the event combinations, thereby judging whether an abnormal behavior occurred within the series of continuative behaviors. Please refer to FIG. 3. FIG. 3 is a schematic view of a continuative behaviors currently performed by the user provided by the embodiments of the instant disclosure. Assuming that the series of continuative behaviors of FIG. 3 occurred at “working hours on Wednesday”. Therefore, the event model of FIG. 2 represents the Markov Model of a series of continuative behaviors that may be performed by the user in during working hours on Wednesday in a period of time in the past; and the continuative behaviors of FIG. 3 represents a series of continuative behaviors currently performed by the user in the working hours on Wednesday.

Since the context awareness information corresponding to the series of continuative behaviors of FIG. 3 (i.e., working hours on Wednesday) conforms to a context recognition index of one of the event combinations of FIG. 2, the integrated analysis module 17 selects the behavioral evaluation model of FIG. 2 as an expected behavior model, thereby judging whether an abnormal behavior occurred within the series of continuative behaviors of FIG. 3.

To be specific, according to the behavioral evaluation model of FIG. 2 (i.e., the Markov Model of FIG. 2), the integrated analysis module 17 may know what continuative behaviors (for example, behavior A, behavior B, behavior C and behavior D) have been performed on the personal computer during the working hours on every Wednesday in the past. However, in the series of continuative behaviors currently performed by the user (i.e., FIG. 3), there are performances of behavior E and behavior F, and the order of the performances is different from the probability distribution of the Markov Model in FIG. 2. Accordingly, based on the above significant difference, the integrated analysis module 17 may judge that an abnormal behavior might have occurred within the series of continuative behaviors currently performed.

From a more perspective view, the cause of the abnormal behavior may be that the series of continuative behaviors is performed by a person other than the regular user, i.e., the continuative behaviors may be an operating behavior by a hacker during a malicious intrusion. Therefore, the system 1 of the embodiments of the instant disclosure may find out the intension of the hacker by the series of continuative behaviors, thereby evaluating the current threat level and carrying out an adequate protection solution. It is worthwhile to mention that the above description is only an example for carrying out the embodiments of the instant disclosure, and the instant disclosure is not limited thereto.

In sum, the spirit of the instant disclosure resides in modeling the continuative behaviors of a user according to a plurality of application level logs and selecting models in consideration of different contexts (for example, location and time), thereby increasing the accuracy of the judgment and the flexibility of the application thereof. In addition, different from the prior art which are mostly judged based on a single behavior, the instant disclosure models and judges based on the continuative behaviors of the user, therefore, the instant disclosure may efficiently find out the intension of the user by analyzing and comparing the differences during the continuative behaviors, thereby increasing the accuracy of judging whether there is an abnormal behavior.

On the other hand, since the context characteristic values and the behavioral sequential data retrieved by the detecting module 11 according to the application level logs may be numerous and complicated, the processing time of the context-aware learner 13 and the personal behavioral modeling learner 15 may be increased. Accordingly, during the actual implementation, the context-aware learner 13 of the instant disclosure may analyze the context characteristic values based on the behavioral evaluation models created by the personal behavioral modeling learner 15 at the same time, thereby creating the context recognition indexes associated with the user. Likewise, the personal behavioral modeling learner 15 of the embodiments of the instant disclosure may model the behavioral sequential data based on the context recognition indexes created by the context-aware learner 13, thereby creating the behavioral evaluation models associated with the user.

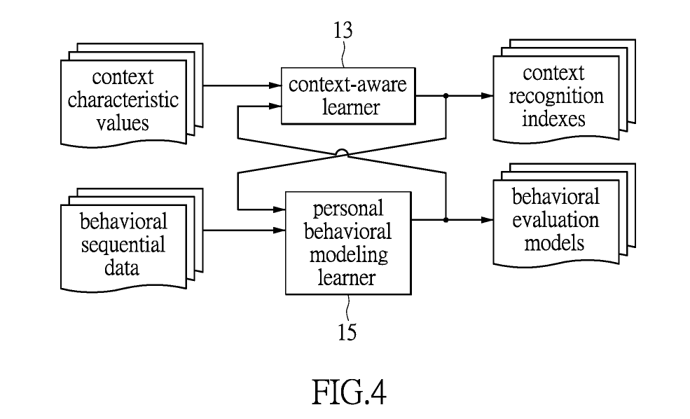

For detailed information, please refer to FIG. 4. FIG. 4 is a schematic view of the interaction between the context-aware learner and personal behavioral modeling learner of the system for information security management provided by the embodiments of the instant disclosure. There is an interactive reinforced learning mechanism between the context-aware learner 13 and the personal behavioral modeling learner 15. The above reinforced learning mechanism may improve the correctness of the results output by the context-aware learner 13 and the personal behavioral modeling learner 15.

For example, still referring to the above example, when the context-aware learner 13 first outputs four context recognition indexes “working hours on Monday”, “non-working hours on Monday”, “working hours on Tuesday” and “non-working hours on Tuesday”, the context-aware learner 13 may input these four context recognition indexes into the personal behavioral modeling learner 15 for modeling the behavioral sequential data based on the four context recognition indexes by the personal behavioral modeling learner 15, thereby assisting the personal behavioral modeling learner 15 preferentially to quickly establish the evaluation models for each of the four context recognition indexes along numerous and complicated behavioral sequential data. In the instant disclosure, the specific implementation of the reinforced learning mechanism of the context-aware learner 13 and the personal behavioral modeling learner 15 is not limited, and may be designed according to actual needs or application by those skilled in the art.

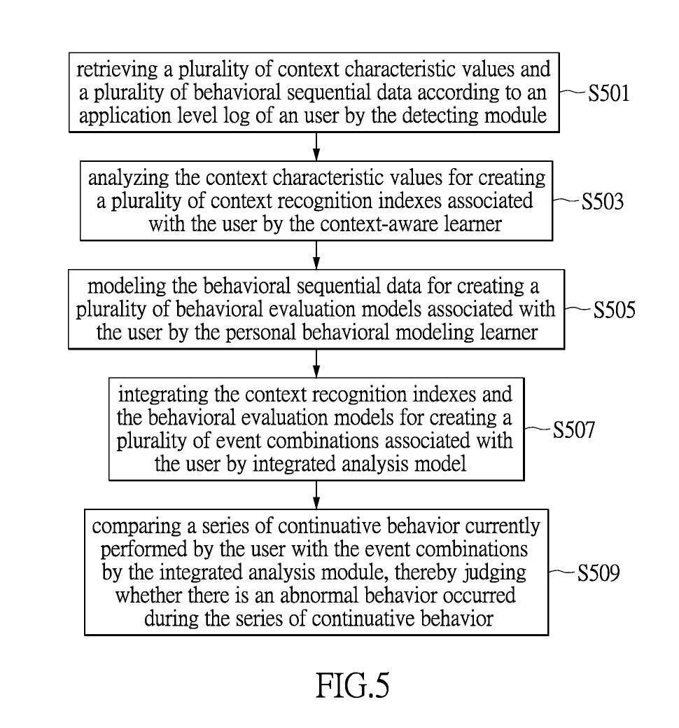

Furthermore, in order to introduce the operating procedure of the system for information security management, the instant disclosure further provides an implementation of the method for information security management. Please refer to FIG. 5. FIG. 5 is a flow chart of a method for information security management based on application level log analysis provided by the embodiments of the instant disclosure. The method described in the present embodiment may be carried out in the system 1 for information security management shown in FIG. 1. Therefore, please refer to FIG. 1 at the same time. In addition, the detailed steps and procedure are mentioned in the previous embodiment, and will not be discussed in detail herein.

First, in step S501, the detecting module 11 retrieves a plurality of context characteristic values and a plurality of behavioral sequential data according to a plurality of application level logs (not shown) of a user. Next, in step S503, the context-aware learner 13 analyzes the context characteristic values for creating a plurality of context recognition indexes associated with the user. In step S505, the personal behavioral modeling learner 15 models the behavioral sequential data for creating a plurality of behavioral evaluation models associated with the user. Next, in step S507, the integrated analysis model 17 integrates the context recognition indexes and the behavioral evaluation models for creating a plurality of event combinations associated with the user. At last, in the step S509, the integrated analysis module 17 compares a series of continuative behaviors currently performed by the user with the event combinations, thereby judging whether an abnormal behavior occurred during the series of continuative behaviors, wherein each of the event combinations comprises at least one of the context recognition indexes and at least one of the behavioral evaluation models.

As described above, since there might be a reinforced learning mechanism between the context-aware learner 13 and a personal behavioral modeling learner 15, those skilled in the art would understand that step S503 and step 505 may be carried out at the same time without conflict with each other. In other words, the context-aware learner 13 may analyze the context characteristic values based on the behavioral evaluation models created by the personal behavioral modeling learner 15 for creating the context recognition indexes, and, at the same time, the personal behavioral modeling learner 15 may model the behavioral sequential data based on the context recognition indexes for creating the behavioral evaluation models associated with the user.

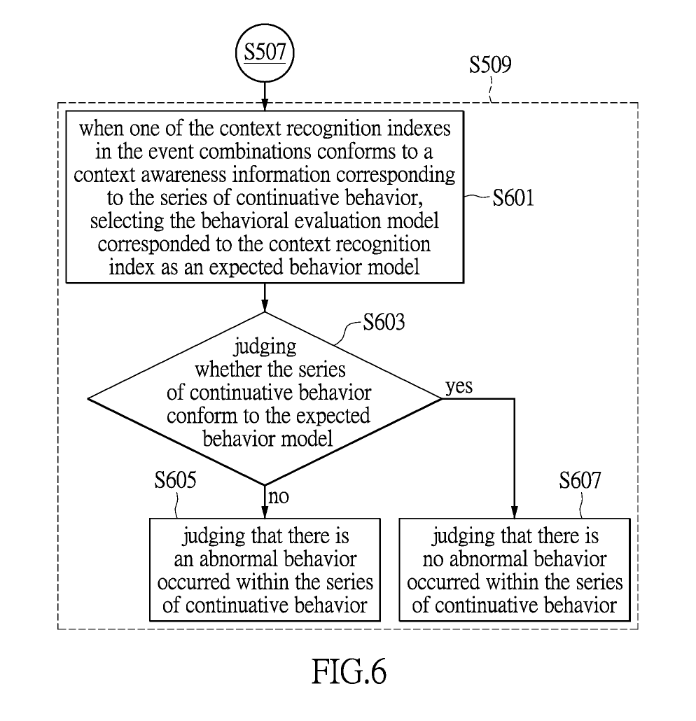

On the other hand, in an embodiment, the instant disclosure further provides an integrated module 15 for judging whether an abnormal behavior occurred within the continuative behaviors (i.e., step S509). Please refer to FIG. 6. FIG. 6 is a flow chart for judging whether an abnormal behavior occurred within the continuative behaviors by the integrated analyzing module in the method for information security management provided by the embodiments of the instant disclosure. In FIG. 6, the process steps identical to those in FIG. 5 are represented by the same reference numbers, and are not described in detail herein.

Please refer to FIGS. 5 and 6 at the same time. Step S509 further comprises steps S601-step S607. First, in step S601, if one of the context recognition indexes in the event combinations conforms to a context awareness information corresponding to the series of continuative behaviors, the integrated analysis module 17 would select the behavioral evaluation model corresponded to the context recognition index as an expected behavior model. Next, in step S603, comparing whether the series of continuative behaviors conform to the expected behavior model. At last, in step S605, if the series of continuative behaviors does not conform to the expected behavior model, the integrated analysis module 17 judges that an abnormal behavior occurred within the series of continuative behaviors. On the contrary, if the series of continuative behaviors conforms to the expected behavior model, the integrated analysis module 17 judges that no abnormal behavior occurred within the series of continuative behaviors.

In summary, the system and method for information security management based on application level log analysis provided by the embodiments of the instant disclosure mainly involves analyzing the application level log of the user and modeling the continuative behaviors of the user. Meanwhile, the selection of models under different contexts is also considered, thereby efficiently judging whether there is an abnormal behavior performed by the user. Besides, since the embodiments of the instant disclosure relate to modeling and judging according to the continuative behaviors of the user, they are able to efficiently identify the intention of the user by analyzing the differences during the continuative behaviors, thereby increasing the accuracy of the judgment of the abnormal behavior.

The above-mentioned descriptions represent merely the exemplary embodiments of the instant disclosure, without any intention to limit the scope of the instant disclosure thereto. Various equivalent changes, alternations or modifications based on the claims of instant disclosure are all consequently viewed as being embraced by the scope of the instant disclosure.

What is claimed is:

1. A system for information security management based on application level log analysis, comprising:
a detecting module configured to retrieve a plurality of context characteristic values and a plurality of behavioral sequential data according to a plurality of application level logs of a user;
a context-aware learner configured to analyze the context characteristic values and creating a plurality of context recognition indexes associated with the user;
a personal behavioral modeling learner configured to model the behavioral sequential data and creating a plurality of behavioral evaluation models associated with the user; and
an integrated analysis module configured to integrate the context recognition indexes and the behavioral evaluation models, and to create a plurality of event combinations associated with the user;
wherein the integrated analysis module compares a series of continuative behaviors currently performed by the user with the event combinations, for judging whether an abnormal behavior occurred within the series of continuative behaviors; and
wherein each of the event combinations comprises at least one of the context recognition indexes and at least one of the behavioral evaluation models.

2. The information security management system according to claim 1, wherein the context-aware learner further analyzes the context characteristic values based on the behavioral evaluation models, thereby creating the context recognition indexes associated with the user.

3. The system according to claim 1, wherein the personal behavioral modeling learner further models the behavioral sequential data based on the context recognition indexes, thereby creating the behavioral evaluation models associated with the user.

4. The system according to claim 1, wherein when one of the context recognition indexes of the event combinations conforms to a context awareness information corresponded to the series of continuative behaviors, the behavioral evaluation model corresponding to the context recognition index is selected as an expected behavior model, and the series of continuative behaviors is further compared with the expected behavior model to judge whether the series of continuative behaviors conform to the expected behavior model, thereby judging whether an abnormal behavior occurred within the series of continuative behaviors.

5. The system according to claim 4, wherein when the series of continuative behaviors does not conform to the expected behavior model, the integrated analysis module judges that an abnormal behavior occurred within the series of continuative behaviors.

6. A method for information security management based on application level log analysis, adapted to a system comprising a detecting module, a context-aware learner, a personal behavioral modeling learner, and an integrated analysis module, wherein the method comprises:
retrieving a plurality of context characteristic values and a plurality of behavioral sequential data according to a plurality of application level logs of a user by the detecting module;
analyzing the context characteristic data by the context-aware learner to create a plurality of context recognition indexes associated with the user;
modeling the behavioral sequential data by the personal behavioral modeling learner to create a plurality of behavioral evaluation models associated with the user;
integrating the context recognition indexes and the behavioral evaluation models by the integrated analysis module to create a plurality of event combinations associated with the user, and
comparing the event combinations with a series of continuative behaviors currently performed by the user by the integrated analysis module so as to judge whether an abnormal behavior occurred within the series of continuative behaviors, wherein each of the event combinations comprises at least one of the context recognition indexes and at least one of the behavioral evaluation models.

7. The method according to claim 6, wherein the context-aware learner further analyzes the context characteristic values based on the behavioral evaluation models for creating the context recognition indexes associated with the user.

8. The method according to claim 6, wherein the personal behavioral modeling learner further models the behavioral sequential data based on the context recognition indexes for creating the behavioral evaluation models associated with the user.

9. The method according to claim 6, wherein the integrated analysis module performs the following steps for judging whether an abnormal behavior occurred within the continuative behaviors:
when one of the context recognition indexes of the event combinations conforms to a context aware information corresponded to the series of continuative behaviors, the behavioral evaluation model corresponding to the context recognition index is selected as an expected behavior model, and the series of continuative behaviors is further compared with the expected behavior model to judge whether the series of continuative behaviors conforms to the expected behavior model, thereby judging whether an abnormal behavior occurred within the series of continuative behaviors.

10. The method according to claim 9, wherein when the series of continuative behaviors does not conform to the expected behavior model, the integrated analysis module judges that an abnormal behavior occurred within the series of continuative behaviors.
